(19) United States
(12) Patent Application Publication
(10) Pub. No.: US 2021/0150493 A1
(43) Pub. Date: May 20, 2021

(54) INFORMATION PROCESSING APPARATUS AND INFORMATION PROCESSING METHOD

(71) Applicant: BANK INVOICE CORPORATION, Tokyo (JP)

(72) Inventor: Taro Teshima, Tokyo (JP)

(21) Appl. No.: 17/159,680

(22) Filed: Jan. 27, 2021

Related U.S. Application Data
(63) Continuation of application No. PCT/JP2019/030378, filed on Aug. 1, 2019.

(30) Foreign Application Priority Data
Aug. 2, 2018 (JP) 2018-145826

(51) Int. Cl. G06Q 20/02; G06Q 30/04; G06Q 40/02

(52) U.S. Cl. CPC G06Q 20/027; G06Q 40/025; G06Q 30/04

(57) ABSTRACT

There are provided an invoice data storage unit that stores therein, upon receiving invoice data that is addressed to a recipient from an issuer via a terminal device over a network and designates the issuer as a payment destination of a payment to be made by the recipient, the received invoice data in association with the identification information of both the issuer and the recipient, and a data processing unit that presents, when receiving, from the issuer via the terminal device, a payment instruction requesting a third party other than the recipient to make the payment after receiving the invoice data, a payment amount calculated based on information on the recipient by the third party to the issuer via the terminal device, and changes, when the issuer receives the payment from the third party, the payment destination indicated in the invoice data from the issuer to the third party.

### RELATED APPLICATIONS

This application claims priority under 35 U.S.C. § 120 to, and is a continuation of, co-pending International Application PCT/JP2019/030378, filed Aug. 1, 2019 and designating the US, which claims priority to co-pending JP Application 2018-145826, filed Aug. 2, 2018, such JP Application also being claimed priority to under 35 U.S.C. § 119. These JP and International applications are incorporated by reference herein in their entireties.

### FIELD

The embodiment discussed herein relates to an information processing apparatus and an information processing method.

### BACKGROUND

As a means of settlement, there is known a service in which accounts receivable from a client, such as invoices, are assigned to the third-party organization so as to convert the accounts receivable into cash soon.

Please see, for example, “GMO B2B early payment” [online], GMO PAYMENT GATEWAY (searched on Jul. 24, 2018 over the Internet) (URL: https://www.gmo-pg.com/service/hayabarai/).

An invoice, when issued, indicates an account number for receiving a payment from a bill-to party. In the case the above-described system is used for early conversion of accounts receivable into cash, the bill-to party needs to be changed after the invoice is issued. The re-issuance of the invoice is a troublesome task for both the issuer and recipient of the invoice.

### SUMMARY

According to one aspect, there is provided an information processing apparatus including: a memory that stores therein, upon receipt of invoice data addressed to a specified recipient from an issuer via a terminal device over a network, the received invoice data in association with identification information of the recipient and identification information of the issuer, the invoice data designating the issuer as a payment destination of a payment to be made by the recipient; and a processor that is coupled to the memory and is configured to perform a process including presenting, in response to receiving, from the issuer via the terminal device, a payment instruction requesting a third-party payment organization other than the recipient to make the payment after receiving the invoice data, a payment amount calculated based on information on the recipient by the third-party payment organization to the issuer via the terminal device, and changing, in response to the issuer receiving the payment from the third-party payment organization, the payment destination indicated in the invoice data from the issuer to the third-party payment organization, wherein the processor displays, on a display unit, the invoice data for which the payment has been received from the third-party payment organization and identifying information indicating receipt of the payment from the third-party payment organization, and displays, in response to the identifying information being selected, an amount of the payment made by the third-party payment organization.

The issuer here is not limited to a person who actually issues the business document data, but may mean any entity that issues the business document data, such as the department, company, or another to which the person who issues the business document data belongs. In addition, the recipient is not limited to a person who receives the business document data, but may means any entity that receives the business document data, such as the department, company, or another to which the person who receives the business document data belongs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to one embodiment;

FIG. 2 is a view for explaining an example of a screen that is displayed on a terminal device after a login;

FIG. 3 illustrates a hardware configuration of an invoice management apparatus according to the embodiment;

FIG. 4 is a block diagram illustrating functions of the invoice management apparatus according to the embodiment;

FIG. 5 is a view for explaining an example of invoice data;

FIG. 6 is a view for explaining information that is displayed in a summary display area;

FIGS. 7A and 7B are views for explaining information that is displayed in the summary display area;

FIG. 8 is a view for explaining an example of external communication data;

FIG. 9 is a view for explaining an example of attached file data;

FIG. 10 is a view for explaining an example of history data;

FIG. 11 is a view for explaining an example of memo data;

FIG. 12 illustrates a management screen that is displayed when a Sent button is selected;

FIGS. 13 and 14 are views for explaining a factoring process;

FIG. 15 illustrates an example of a payable amount that is displayed on the management screen; and

FIG. 16 is a view for explaining invoice data for which the payment is received from a third-party payment organization.

### DETAILED DESCRIPTION

Hereinafter, an invoice management system according to one embodiment will be described in detail with reference to the accompanying drawings.

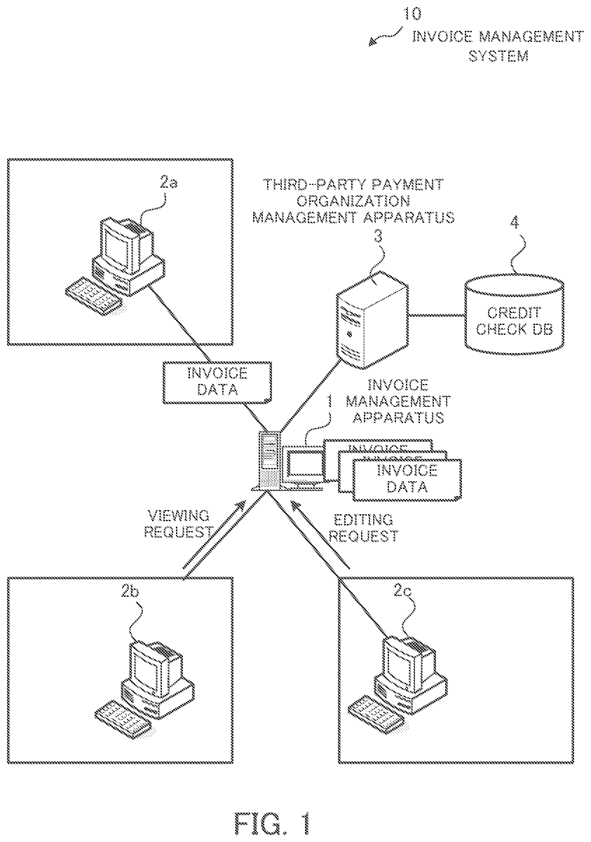

FIG. 1 illustrates an invoice management system according to one embodiment.

In the invoice management system 10 of the embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personal computers, laptop personal computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the present embodiment explains communication of invoice data, but invoices are an example of business documents and the present embodiment is not limited thereto. Other examples of business documents include estimate forms and order forms.

Hereinafter, it is assumed that the invoice management system 10 is used by the individual accounting personnel of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting personnel are able to operate their terminal devices 2a, 2b, and 2c to process invoice data, which is a digitized version of original invoices, via the invoice management apparatus 1. The processing of invoice data includes creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

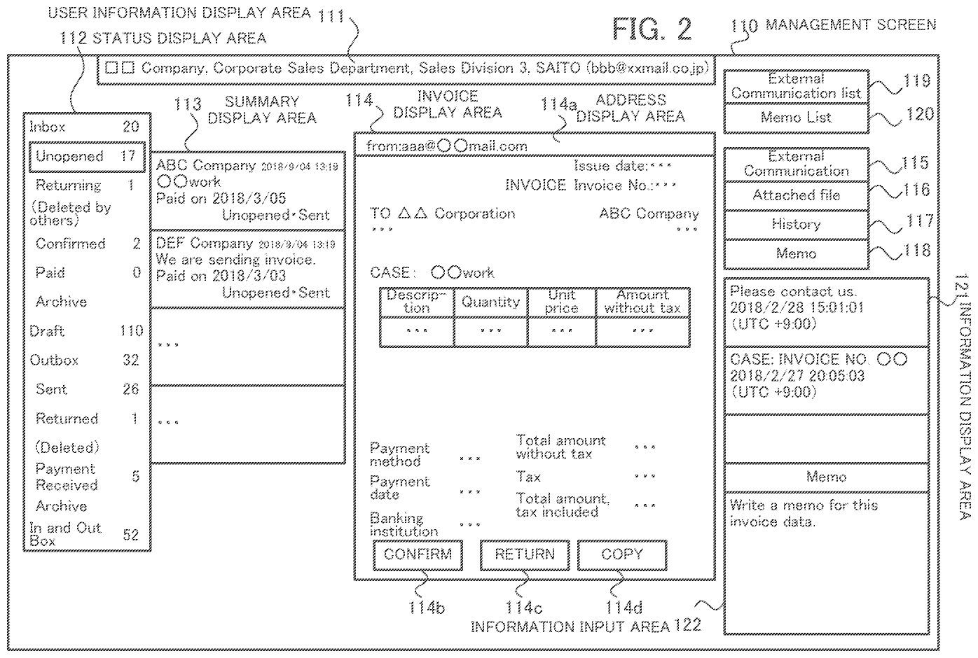

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

The management screen 100 will be described in detail later.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

Refer back to FIG. 1. A third-party payment organization management apparatus 3 owned by a third-party payment organization is connected to the invoice management apparatus 1 over a network.

Now, the case where the accounting personnel of the company A issues an invoice addressed to the company B will be described by way of example. After receiving the invoice data issued by the accounting personnel of the company A, the invoice management apparatus 1 is able to receive an instruction to receive the payment relating to the invoice data from the third-party payment organization other than the company B, from the accounting personnel of the company A via the management screen 110 (terminal device 2a). At this time, the invoice management apparatus 1 sends the third-party payment organization management apparatus 3 an inquiry of whether it is possible to make the payment for the invoice data. The third-party payment organization management apparatus 3 determines on the basis of prescribed determination criteria whether it is possible to make the payment for the invoice data (whether it is possible to accept the assignment of the accounts receivable). The determination criteria are not limited to any particular criteria, but for example, the following method is considered: the third-party payment organization management apparatus 3 accesses a credit check database (DB) 4 connected thereto over a network to check the objective credit status of the company B, such as the financial statement published by the company B, the past payment history (existence or absence of late payment) of the company B, and information regarding transaction details (collection of claim, adjustment of debts, performance of guarantee, compulsory cancellation, petition for bankruptcy, assignment of receivables). In the case where the bill-to party is a private person, his/her credit information or the like may be used as the determination criteria.

In the case where the third-party payment organization management apparatus 3 determines that it is possible to make the payment, the third-party payment organization management apparatus 3 calculates a payable amount, and then notifies the invoice management apparatus 1 of the calculated payable amount.

In general, as the company B has a higher credit score, the payable amount more approaches the amount billed by the company A, and as the company B has a lower credit score, the payable amount is more away from the amount billed by the company A. For example, assume that the billing amount is 1,000,000 yen. If the company B has a high credit score, there is a high possibility that the third-party payment organization is able to receive the billing amount of 1,000,000 yen from the company B. In this case, for example, the third-party payment organization management apparatus 3 may notify the invoice management apparatus 1 of 980,000 yen as the calculated payable amount. If the company B has a low credit score, however, there is a low possibility that the third-party payment organization management apparatus 1 is able to receive the billing amount of 1,000,000 yen. In this case, for example, the third-party payment organization apparatus 3 may notify the invoice management apparatus 1 of 100,000 yen as the calculated payable amount.

The invoice management apparatus 1 presents the payable amount notified of by the third-party payment organization management apparatus 3 on the management screen 110.

In the case where the accounting personnel of the company A who confirms the payable amount would like to receive the payment of the payable amount from the third-party payment organization, the accounting personnel of the company A uses the management screen 110 to accept the payment of the payable amount from the third-party payment organization. The invoice management apparatus 1 receives the acceptance and requests the third-party payment organization management apparatus 3 to pay the payable amount. After that, the third-party payment organization management apparatus 3 transfers the payable amount into the account that is indicated in the invoice data and designated by the accounting personnel of the company A. After that, the third-party payment organization management apparatus 3 sends a transfer completion notification to the invoice management apparatus 1.

When receiving the transfer completion notification, the invoice management apparatus 1 displays the management screen 110 indicating the completion of the payment of the payable amount for the invoice data on the screen of the terminal apparatus 2.

The above example involves one third-party payment organization. However, not only one third-party payment organization but also a plurality of third-party payment organizations may be involved, although not illustrated. For example, bidding may be offered to a plurality of third-party payment organizations and a third-party payment organization which offers the highest payable amount may be allowed to notify the invoice management apparatus 1 of the payable amount. As another example, the payable amounts of the third-party organizations may be displayed on the screen of the terminal device 2a and the accounting personnel of the company A may select one of the third-party payment organizations for the payment.

Now, the disclosed invoice management system will be described more concretely.

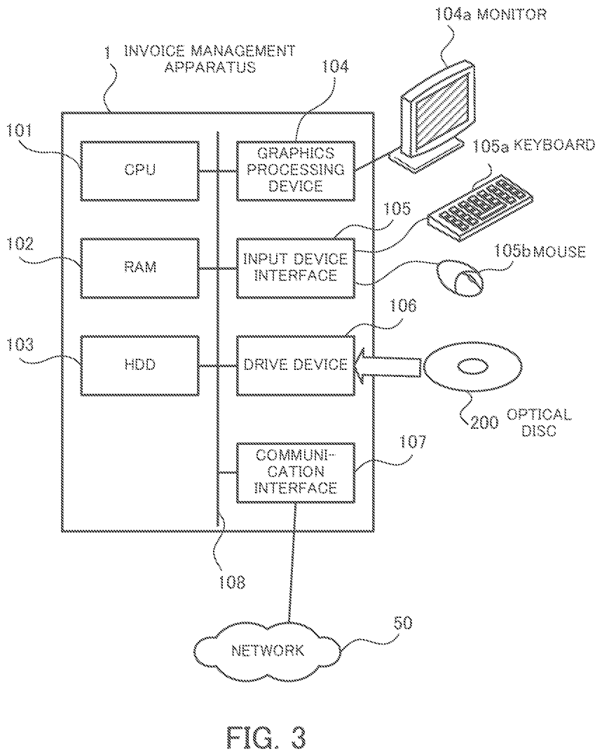

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of an OS (operating system) program and an application program that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. An OS program, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 is provided with functions described below.

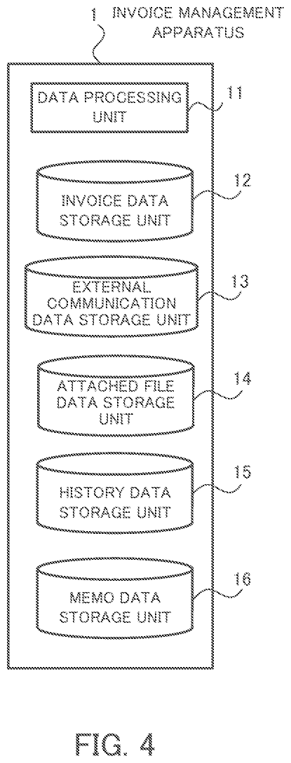

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, and a memo data storage unit 16.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (to be described later) and memos made by an accounting personnel, and others in appropriate storage units.

The invoice data storage unit 12 stores therein invoice data received by the invoice management apparatus 1, by accounting personnel (more specifically, by mail address of accounting personnel). The invoice data received by the invoice management apparatus 1 includes invoice data sent from the accounting personnel of billers to the accounting personnel of bill-to parties and invoice data drafted by the accounting personnel (issuers) of the billers.

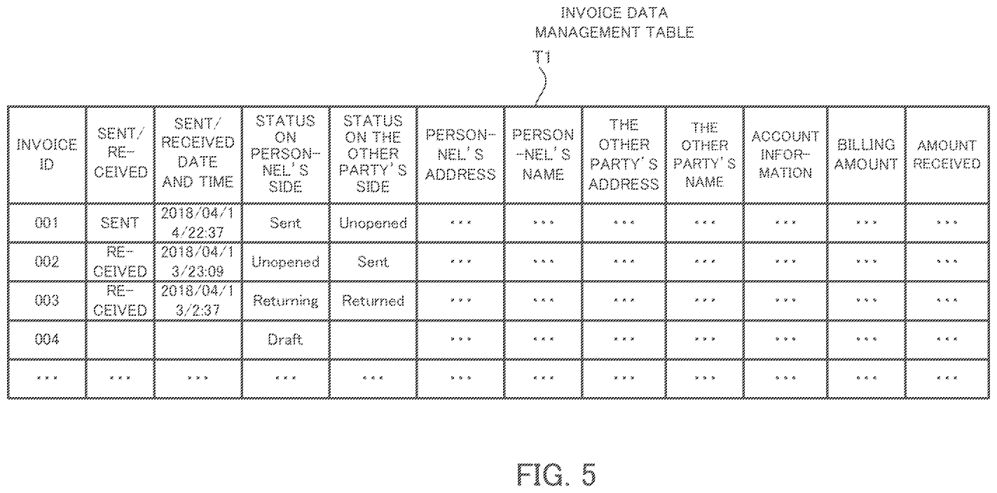

FIG. 5 is a view for explaining an example of invoice data.

In the present embodiment, data is stored in tabular form. The invoice data management table T1 has the following columns: Invoice ID, Sent/Received, Sent/Received Date and Time, Status on Personnel's Side, Status on the Other Party's Side, Personnel's Address, Personnel's Name, the Other Party's Address, the Other Party's Name, Account Information, Billing Amount, and Amount Received. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the name of the accounting personnel.

The Other Party's Address column contains the mail address of the accounting personnel of the other party that communicates the invoice data.

The Other Party's Name column contains the name of the other party that communicates the invoice data.

The Account Information column contains the name and branch number of a banking institution, an account number, and others for receipt of the billing amount.

The Billing Amount column contains the billing amount that is indicated in the invoice data.

The Amount Received column contains the amount received from the third-party payment organization.

In addition to the illustrated information, the invoice data management table T1 contains data on invoices, including the company name and department name of the accounting personnel, the company name and department name of the accounting personnel of the other party that communicates the invoice data, the postal codes and addresses of the individual companies, and breakdown items. In addition, with respect to the amount received, the third-party payment organization or the like which has made the payment may be stored in the invoice data management table T1.

The following describes a management screen.

### Management Screen

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List button 119, a Memo List button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (to be described later), among the invoice data placed in the Inbox folder.

The “Paid” status is given by the data processing unit 11 to invoice data for which the accounting personnel has made payment and then selected a Payment button, not illustrated, among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the contents of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button, not illustrated, among the invoice data placed in the Outbox folder.

The “Archive” status is given by the data processing unit 11 to invoice data which the accounting personnel has saved in the Archive at certain timing, among the invoice data in the “Sent” or “Payment Received” status.

The Archive status in the status display area 112 does not specifically indicate any number.

What is needed to view the contents of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment due, a status on the sender side, and a status on the recipient side.

The same statuses are displayed on the management screens of both the accounting personnel who has sent invoice data and the accounting personnel who has received the invoice data.

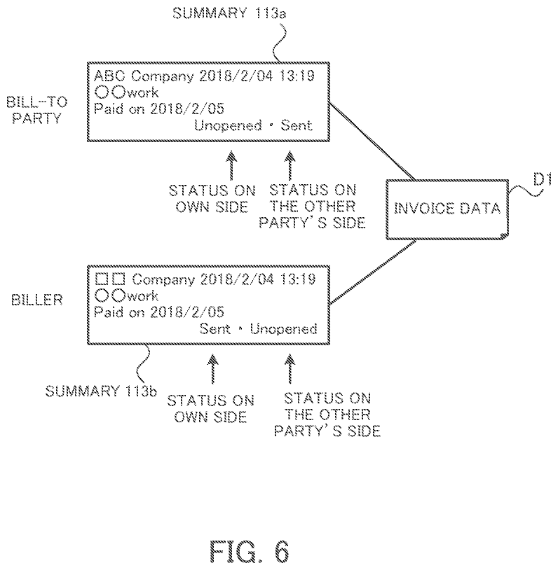

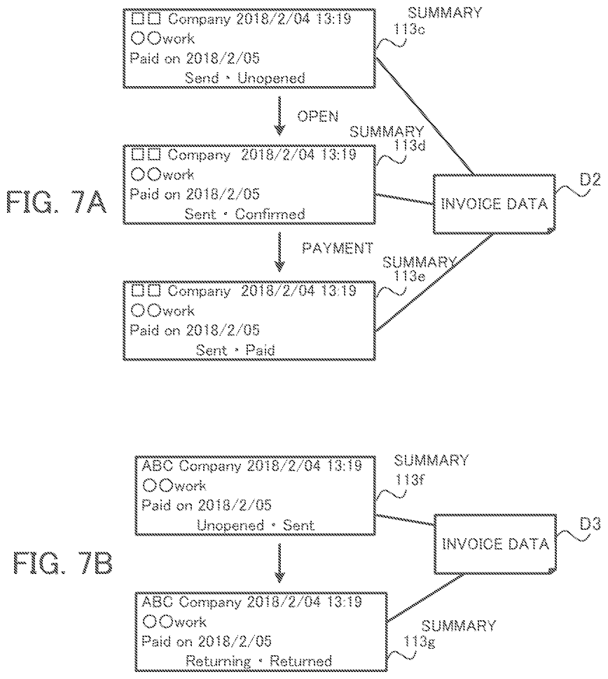

FIGS. 6, 7A, and 7B are views for explaining information that is displayed in the summary display area.

FIG. 6 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of OO work, as illustrated in FIG. 6, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is [symbol] company, a case name is OO work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting personnel of both parties are able to confirm the current status of each invoice data in real-time.

All summaries 113c, 113d, and 113e illustrated in FIG. 7A are of invoice data D2.

When the accounting personnel of the bill-to party has viewed the invoice data D2 and selected a Confirm button (to be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button, not illustrated, the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 7B are of invoice data D3.

When the accounting personnel of the bill-to party has viewed the invoice data D3 and selected a Return button (to be described later), the data processing unit 11 changes information displayed in the summary display area 113 from the summary 113f to the summary 113g on the management screen of the terminal device operated by the accounting personnel of the bill-to party.

Refer now back to FIG. 2. When the accounting personnel has selected the summary of invoice data being displayed in the summary display area 113, the data processing unit 11 displays the contents of the invoice in the invoice display area 114. The contents of the invoice to be displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “Confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned.” In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

Refer back to FIG. 2. Among all invoice data placed in the Inbox and Outbox folders, data other than deleted invoice data, invoice data saved in the archive, and invoice data in the Draft status is placed in the In and Out Box folder.

### External Communication Button

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

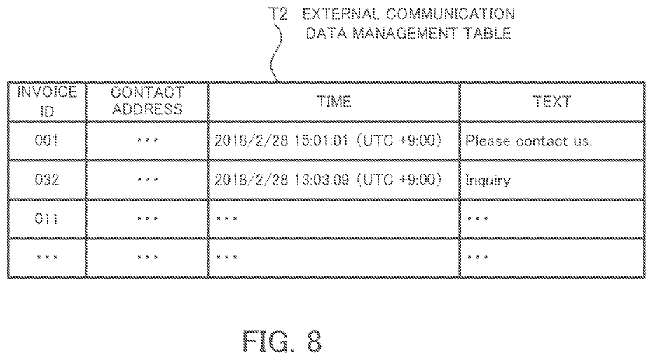

FIG. 8 is a view for explaining an example of external communication data.

In the present embodiment, external communication data is stored in tabular form.

The external communication data management table T2 has the following columns: Contact Address, Invoice ID, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the contents of the external communication.

In addition, in the external communication input mode, the data processing unit 11 refers to the external communication data management table T2 with respect to the invoice data being displayed in the invoice display area 114, and displays the external communications created so far, together with the fixed dates and times in chronological order in the information display area 121.

The information display area 121 displays external communications entered by the accounting personnel of both the sender and the recipient of the invoice data. Therefore, this external communication input mode enables these accounting personnel to perform communications like chats with each other.

In this connection, other processing (downloading, conversion to PDF format, and others) performed by the accounting personnel on the invoice data being displayed in the invoice data display area 114 may be indicated in the information display area 121 together with the execution dates and times of the processing. This enables both the accounting personnel to know the history on each other's processing.

### Attached File Button

When the accounting personnel selects the Attached File button 116, the data processing unit 11 switches the management screen 110 into an attached file mode. In this attached file mode, when the accounting personnel clicks and drags attached data into the information input area 112 and presses the enter key of the keyboard or the like to fix this operation, the data processing unit 11 stores the attached data in the attached file data storage unit 14 in association with the mail address of the accounting personnel and the invoice data being displayed in the invoice display area 114.

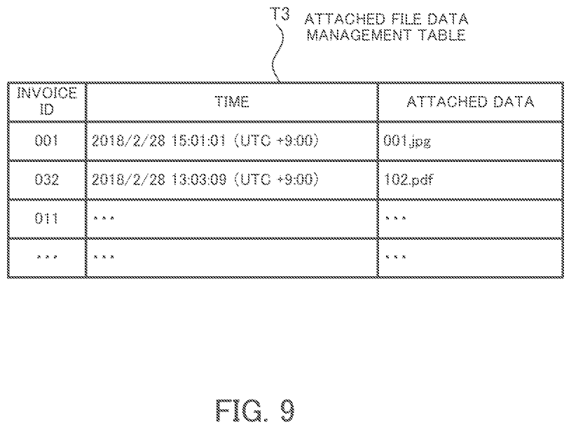

FIG. 9 is a view for explaining an example of attached file data.

In the present embodiment, attached file data is stored in tabular form.

The attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

### History Button

The data processing unit 11 stores a history (history data) on operations made so far by the accounting personnel of both parties in the history data storage unit 15.

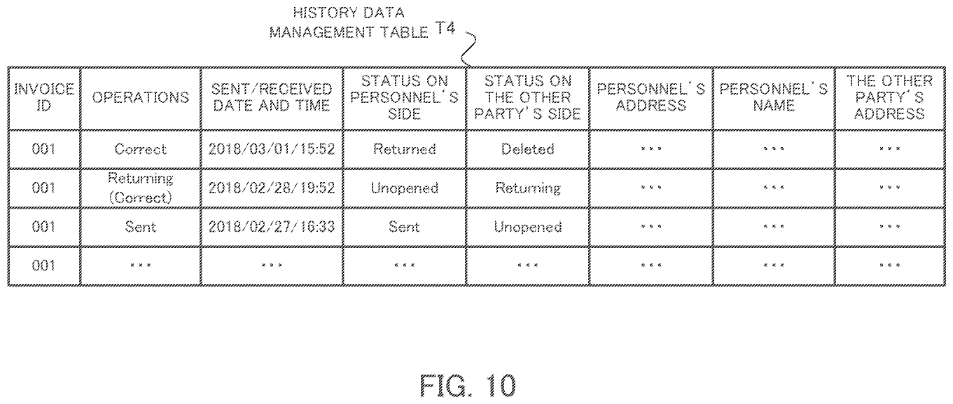

FIG. 10 is a view for explaining an example of the history data.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Contact Name, and The Other Party's Address. Information pieces arranged in a horizontal direction are associated with each other.

The Operations column contains an operation made by the accounting personnel. The other columns have the same contents as those of the invoice data management table T1, and therefore the description of these columns will not be repeated.

### Memo Button

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

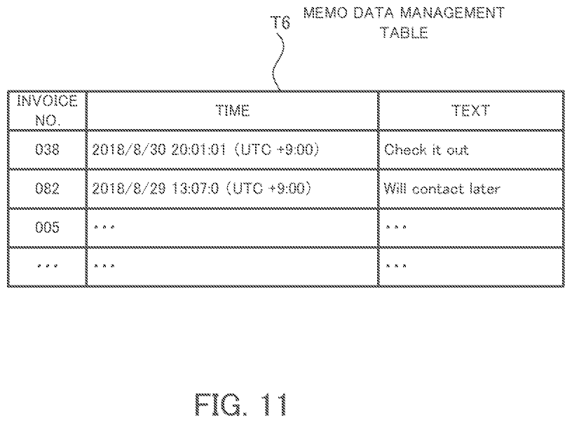

FIG. 11 is a view for explaining an example of memo data.

In the present embodiment, memo data is stored in tabular form.

The memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the contents of the memo.

In addition, in the memo input mode, the data processing unit 11 accesses the memo data storage unit 16 to display memos created so far about invoice data being displayed in the invoice display area 114 in chronological order in the information display area 121.

Refer now back to FIG. 2 again.

### External Communication List Button

When the accounting personnel selects the External Communication List button 119, the data processing unit 11 accesses the external communication data storage unit 13 storing therein data about external communications, and displays a list screen (external communication list screen) regarding external communications about invoices handled by the accounting personnel in chronological order on the management screen 110.

### Memo List Button

When the accounting personnel selects the Memo List button 120, the data processing unit 11 accesses the memo data storage unit 16 storing therein data on external communications, to display a list screen (memo list screen) of memos regarding invoices handled by the accounting personnel in chronological order on the management screen 110.

The following describes a factoring process according to the present embodiment.

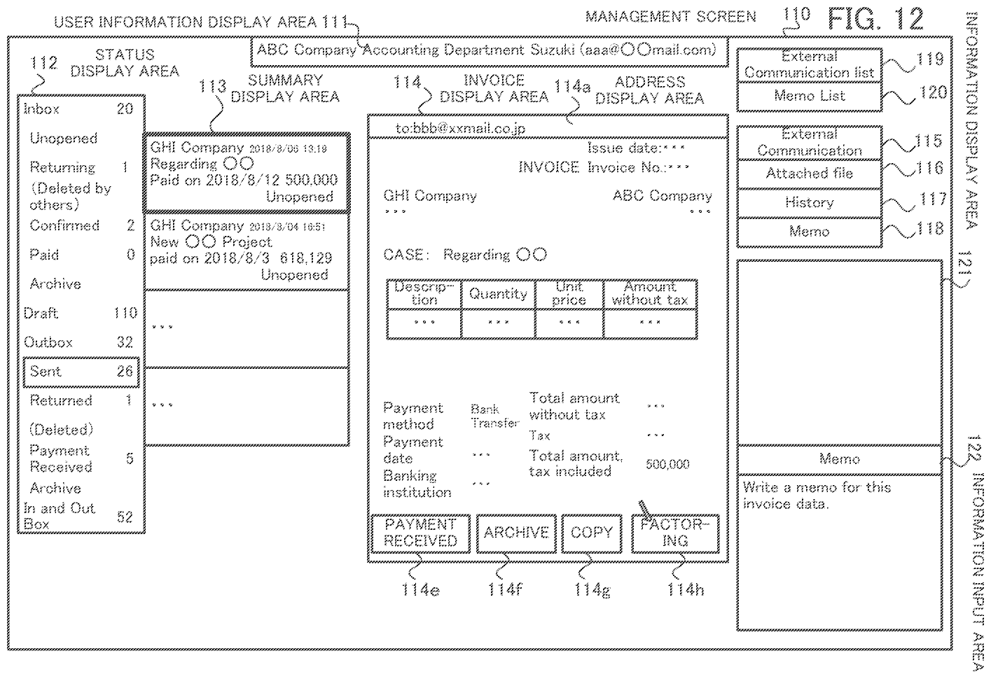

FIG. 12 illustrates a management screen that is displayed when the Sent button is selected.

The invoice display area 114 includes a Payment Received button 114e, an Archive button 114f, a Copy button 114g, and Factoring button 114h.

When the accounting personnel selects the Payment Received button 114e, the data processing unit 11 refers to the invoice data management table T1. Then, the data processing unit 11 changes the Status on Personnel's Side column to “Payment Received” with respect to the invoice data being displayed in the invoice display area 114. In addition, the data processing unit 11 decreases the number for the “Sent” status by one and increases the number for the “Payment Received” status by one in the status display area 112.

When the accounting personnel selects the Archive button 114f, the data processing unit 11 refers to the invoice data management table T1. Then, the data processing unit 11 changes the Status on Personnel's Side column to “Archive” with respect to the invoice data being displayed in the invoice display area 114. In addition, the data processing unit 11 decreases the number for the “Sent” status by one in the status display area 112.

When the accounting personnel selects the Copy button 114d, the data processing unit 11 creates invoice data reflecting the company names and addresses of the biller and bill-to party of the invoice data. Then, the data processing unit 11 stores information on the created invoice data in the invoice data management table T1. At this time, the Status on Personnel's Side column for the invoice data is set to “Draft,” and the Status on the Other Party's Side column is set blank.

When the accounting personnel selects the Factoring button 114h, the data processing unit 11 performs the following factoring process in collaboration with the third-party payment organization management apparatus 3.

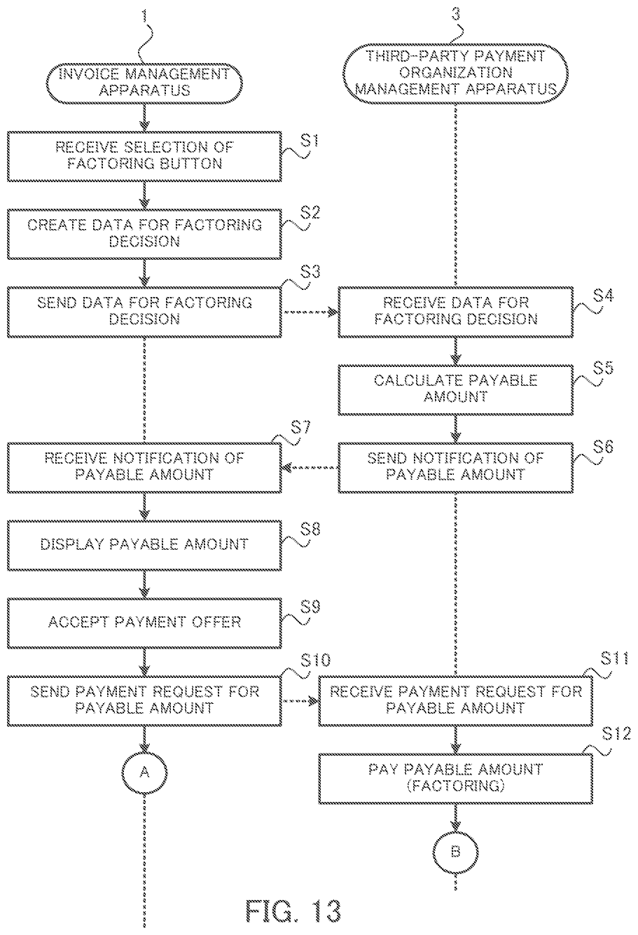

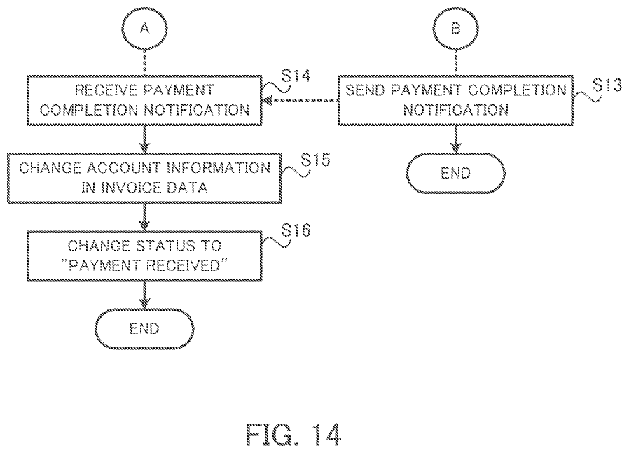

FIGS. 13 and 14 are views for explaining the factoring process.

In the following description, assume that the company A is a biller and the company B is a bill-to party.

(Step S1) The data processing unit 11 accepts the selection of the Factoring button 114h. Then, the process proceeds to step S2.

(Step S2) The data processing unit 11 creates data for factoring decision, for causing the third-party payment organization management apparatus 3 to determine whether it is possible to accept the assignment of the accounts receivable. The data for factoring decision here may be invoice data itself or part of the invoice data, such as the invoice ID, the company name (company B) of the bill-to party, billing amount, and others indicated in the invoice data.

(Step S3) The data processing unit 11 sends the created data for factoring decision to the third-party payment organization management apparatus 3.

(Step S4) The third-party payment organization management apparatus 3 receives the data for factoring decision.

(Step S5) The third-party payment organization management apparatus 3 calculates a payable amount on the basis of the received data for factoring decision. For this determination, the following method is considered, as described earlier: the third-party payment organization management apparatus 3 accesses the credit check DB 4 to check the objective credit status of the company B, such as the financial statement published by the company B, the past payment history (existence or absence of late payment) of the company B, and information regarding transaction details (collection of claim, adjustment of debts, performance of guarantee, compulsory cancellation, petition for bankruptcy, assignment of receivables). In the case where the bill-to party is a private person, his/her credit information or the like may be used as the determination criteria.

(Step S6) The third-party payment organization management apparatus 3 sends a notification of the payable amount calculated at step S5 to the invoice management apparatus 1.

(Step S7) The invoice management apparatus 1 receives the notification of the payable amount.

(Step S8) The data processing unit 11 displays the payable amount on the management screen 110.

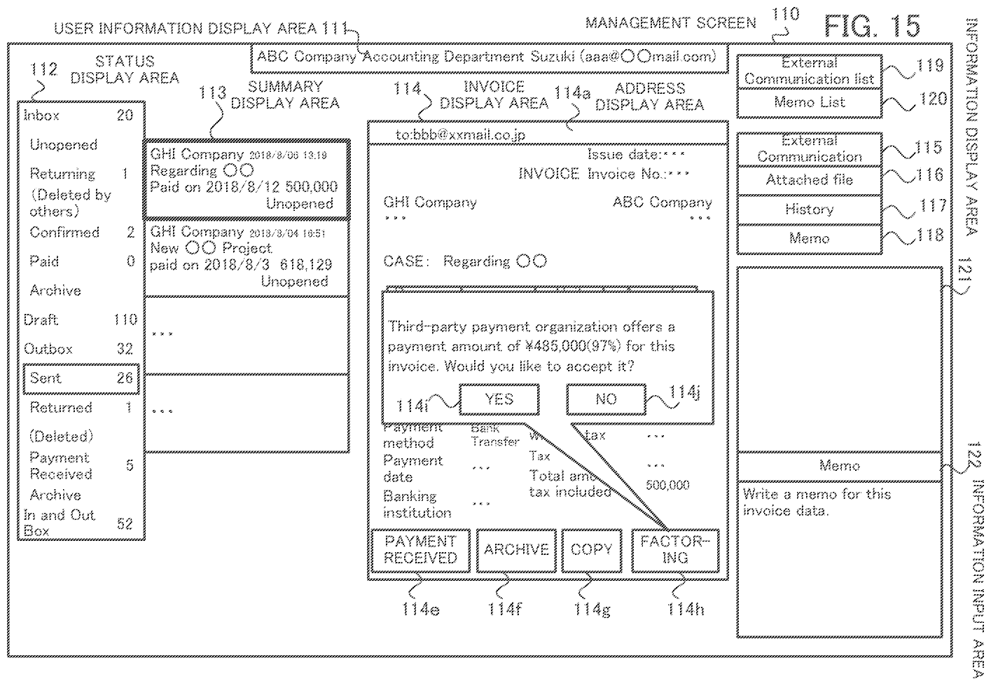

FIG. 15 illustrates an example of the payable amount that is displayed on the management screen.

As an example, FIG. 15 illustrates the case where the company B has a relatively high credit score and the third-party payment organization management apparatus 3 offers 97% (485,000 yen) of the billing amount (500,000 yen) as a payable amount. The data processing unit 11 displays a Yes button 114i and a No button 114j together with the payable amount on the management screen 110. When the accounting personnel of the company A selects the Yes button 114i, the process proceeds to step S9. If the accounting personnel of the company A selects the No button 114j, the process of FIG. 13 is completed.

(Step S9) The data processing unit 11 accepts the selection of the Yes button 114i (acceptance of the payment offer). At this time, the accounting personnel of the company A may select the External Communication button 115 to enter the acceptance of payment from the third-party payment organization in the information input area 122, to thereby notify the accounting personnel of the bill-to party company B of this acceptance.

(Step S10) The data processing unit 11 sends, to the third-party payment organization management apparatus 3a, a payment request for requesting the third-party payment organization to pay the payable amount.

(Step S11) The third-party payment organization management apparatus 3 receives the payment request.

(Step S12) The third-party payment organization management apparatus 3 transfers the payable amount to the designated account set in the account information of the invoice data.

(Step S13) The third-party payment organization management apparatus 3 sends a payment completion notification to the invoice management apparatus 1.

(Step S14) The data processing unit 11 receives the payment completion notification.

(Step S15) The data processing unit 11 refers to the invoice data management table T1 to change the account information (account information designated by the company A) that is an account for transfer, indicated in the invoice data, to account information designated by the third-party payment organization management apparatus 3. In addition, the data processing unit 11 stores the payable amount paid at step S12, in the Amount Received column. After that, in response to a request for viewing the invoice data from the accounting personnel of the company A or the accounting personnel of the company B, the data processing unit 11 displays the third-party payment organization who has paid the payment amount in the banking institution area of the invoice display area 114.

(Step S16) The data processing unit 11 refers to the invoice data management table T1 to change the status of the invoice data to “Payment Received.”

The process of FIG. 14 is completed.

In this connection, the above process is just an example, and another process may be performed between steps or the order of steps may be changed. Also, part of the process may be replaced with another process. For example, a “Factoring Completed” status may be provided, and when the data processing unit 11 sends, to the third-party payment organization management apparatus 3, a payment request for requesting the third-party payment organization to pay the payable amount at step S10, the data processing unit 11 may change the status to “Factoring Completed.” Then, as illustrated in FIG. 14, when the data processing unit 11 receives the payment completion notification, the data processing unit 11 may change the status of the invoice data to “Payment Received.”

By the way, when the company B pays the billing amount, the company B views the invoice data in the “Unopen” or “Confirmed” status and makes the payment to the account of the third-party payment organization displayed as the banking institution in the invoice display area 114.

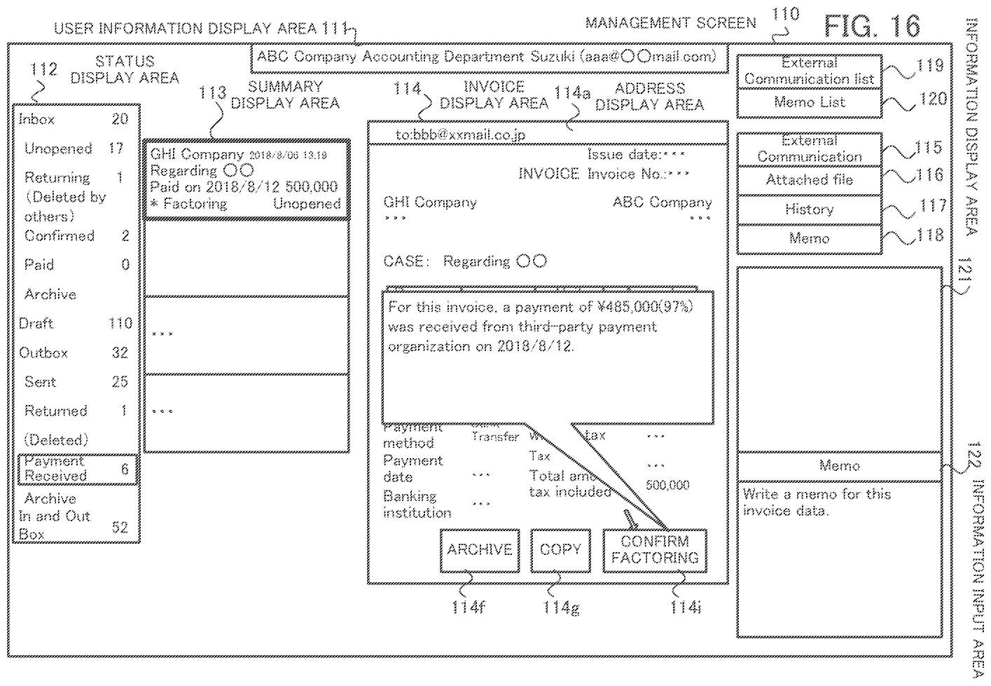

FIG. 16 is a view for explaining invoice data for which payment is received from the third-party payment organization.

With regard to invoice data for which the payment has been received from the third-party payment organization, this information is displayed in the summary display area 113. As an example, referring to FIG. 16, “* Factoring” is displayed.

The invoice display area 114 has a Confirm Factoring button 114i. When the accounting personnel of the company A selects the Confirm Factoring button 114i, the data processing unit 11 refers to the invoice data management table T1 to display the amount indicated in the Amount Received column with respect to the invoice data on the management screen 110. In this connection, the display method of FIG. 16 is just an example.

As described above, the invoice management system 10 includes: the invoice data storage unit 12 that stores therein, upon receipt of invoice data that is addressed to the accounting personnel of the company B serving as a specified recipient from the accounting personnel of the company A via the terminal device 2a over a network and designates the company A as the payment destination of the payment to be made by the company B, the received invoice data in association with the identification information of the accounting personnel of the company A and the identification information of the accounting personnel of the company B; and the data processing unit 11 that presents, in response to receiving, from the accounting personnel of the company A via the terminal device 2a, a payment instruction requesting the third-party payment organization other than the company B to make the payment after receiving the invoice data, a payment amount calculated based on information on the company B by the third-party payment organization to the accounting personnel of the company A via the terminal device 2a, and changes, when the accounting personnel of the company A receives the payment from the third-party payment organization, the payment destination indicated in the invoice data from the company A to the third-party payment organization.

As described above, it is possible to receive payment in a flexible manner with a simple procedure.

In addition, the data processing unit 11 manages the status indicating the processing progress of the invoice data, and when the company A receives the payment of the payment amount made by the third-party payment organization in accordance with an instruction from the accounting personnel of the company A, displays a screen indicating completion of the payment for the invoice data stored in the invoice data storage unit 12, i.e., displays, with reference to the invoice data management table T1, a screen in which the status of the invoice data has been changed to “Payment Received,” via the terminal device 2a. Since the accounting personnel of the company A does not need to manually change the status, the management of the invoice data is simplified.

Note that invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting personnel of both the sender and the recipient of invoice data. Therefore, using the external communication input mode enables the accounting personnel of both parties to perform communications like chats.

Information on invoice data is stored in the invoice data management table T1 when the invoice data is sent, and the statuses of subsequent transactions are managed using this invoice data management table T1. Therefore, the accounting personnel is able to get away from manually compiling invoices into a data sheet.

Note that the processing performed by the invoice management apparatus 1 may be performed in a distributed manner by a plurality of apparatuses.

In addition, in the present embodiment, the invoice management apparatus 1 is provided with various storage units including the invoice data storage unit 12. The embodiment is not limited thereto, and cloud storage may be provided, instead of the various storage units, at a location different from the data processing unit 11.

The money treated in the embodiment includes virtual currency.

In addition, in the present embodiment, the third-party payment organization management apparatus 3 is provided separate from the invoice management apparatus 1. Alternatively, the invoice management apparatus 1 may be provided with the functions of the third-party payment organization management apparatus 3.

Heretofore, the information processing apparatus and information processing method of the present invention have been described in the embodiment illustrated. The invention is not limited thereto, and the components of each unit may be replaced with other components having equivalent functions or other components. In addition, other desired configurations and steps may be added.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, flexible disks (FDs), magnetic tapes, etc. The optical discs include DVDs, DVD-RAMs, CD-ROMs, CD-RWs, etc. The magneto-optical recording media include MOs (magneto-optical disks), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to receive payment in a flexible manner with a simple procedure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory that stores therein, upon receipt of invoice data addressed to a specified recipient from an issuer via a terminal device over a network, the received invoice data in association with identification information of the recipient and identification information of the issuer, the invoice data designating the issuer as a payment destination of a payment to be made by the recipient; and
a processor that is coupled to the memory and is configured to perform a process including presenting, in response to receiving, from the issuer via the terminal device, a payment instruction requesting a third-party payment organization other than the recipient to make the payment after receiving the invoice data, a payment amount calculated based on information on the recipient by the third-party payment organization to the issuer via the terminal device, and
changing, in response to the issuer receiving the payment from the third-party payment organization, the payment destination indicated in the invoice data from the issuer to the third-party payment organization,
wherein the processor displays, on a display unit, the invoice data for which the payment has been received from the third-party payment organization and identifying information indicating receipt of the payment from the third-party payment organization, and displays, in response to the identifying information being selected, an amount of the payment made by the third-party payment organization.

2. The information processing apparatus according to claim 1, wherein the processor displays the identifying information in a summary display area displaying a summary of the invoice data.

3. The information processing apparatus according to claim 1, wherein the payment amount is calculated based on a credit score of the recipient.

4. An information processing method comprising:
referring, by a computer, to a memory that stores therein, upon receipt of invoice data addressed to a specified recipient from an issuer via a terminal device over a network, the received invoice data in association with identification information of the recipient and identification information of the issuer, the invoice data designating the issuer as a payment destination of a payment to be made by the recipient;
presenting, by the computer, in response to receiving, from the issuer via the terminal device, a payment instruction requesting a third-party payment organization other than the recipient to make the payment after receiving the invoice data, a payment amount calculated based on information on the recipient by the third-party payment organization to the issuer via the terminal device;
changing, by the computer, in response to the issuer receiving the payment from the third-party payment organization, the payment destination indicated in the invoice data from the issuer to the third-party payment organization; and
displaying, by the computer, on a display unit, the invoice data for which the payment has been received from the third-party payment organization and identifying information indicating receipt of the payment from the third-party payment organization, and displaying, in response to the identifying information being selected, an amount of the payment made by the third-party payment organization.

5. A non-transitory computer-readable storage medium storing a computer program that causes a computer to perform a process comprising:
referring to a memory that stores therein, upon receipt of invoice data addressed to a specified recipient from an issuer via a terminal device over a network, the received invoice data in association with identification information of the recipient and identification information of the issuer, the invoice data designating the issuer as a payment destination of a payment to be made by the recipient;
presenting, in response to receiving, from the issuer via the terminal device, a payment instruction requesting a third-party payment organization other than the recipient to make the payment after receiving the invoice data, a payment amount calculated based on information on the recipient by the third-party payment organization to the issuer via the terminal device;
changing, in response to the issuer receiving the payment from the third-party payment organization, the payment destination indicated in the invoice data from the issuer to the third-party payment organization; and
displaying, on a display unit, the invoice data for which the payment has been received from the third-party payment organization and identifying information indicating receipt of the payment from the third-party payment organization, and displaying, in response to the identifying information being selected, an amount of the payment made by the third-party payment organization.
